(19) United States
(12) Patent Application Publication
(10) Pub. No.: US 2007/0011014 A1
(43) Pub. Date: Jan. 11, 2007

(54) Method and system of accounting transactions through concurrent processing of events in cyber space

(76) Inventor: Prakasham Umapathy, Chennai (IN)

Correspondence Address: MERCHANT & GOULD PC, P.O. BOX 2903, MINNEAPOLIS, MN, 55402-0903, US

(21) Appl. No.: 10/570,055

(22) PCT Filed: May 17, 2004
(86) PCT No.: PCT/IN04/00136

§ 371 Date: Feb. 28, 2006

Related U.S. Application Data
(60) Provisional application No. 60/499,013, filed on Sep. 2, 2003.

(51) Int. Cl. G06Q 99/00; G07G 1/00; G06F 17/30; G07F 19/00; G07B 17/00

(52) U.S. Cl. 705/1; 705/10; 705/30

(57) ABSTRACT

New Method and System of Accounting transactions through processing of transaction events in Cyber Space. Comprises recording of events with handles defining the transaction flow in securely accessible, shared multiple data bases. The floating events data base stores events in transition until completion of their pre-defined life cycles and archieved events data base consists of completed transactions. Primary Application and Database resides on a network server accessible by a plurality of client computers enabling secured access, reducing total database requirement, acknowledging transactions, synchronizing primary and secondary systems and enabling concurrent preparation of accounts of multiple entities with an embedded reconciliation statement generation mechanism. The secondary system with local database and application handles offline processing of internal and external transactions, customized report generation and confidential data storage to meet the specific requirements of the users including generation of traditional accounting records in multiple, diverse accounting systems and currencies.

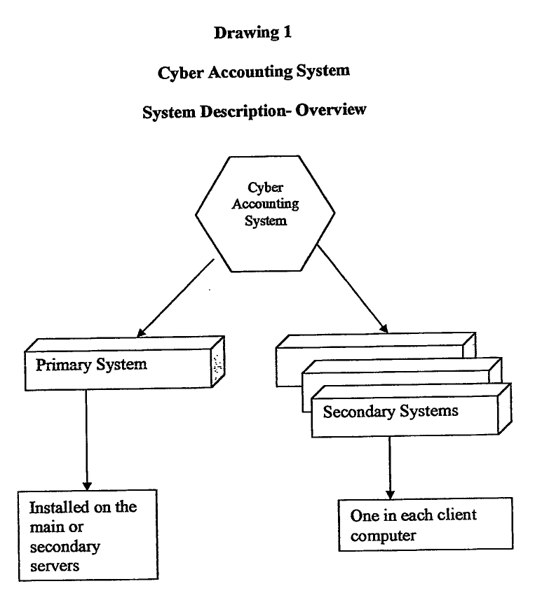

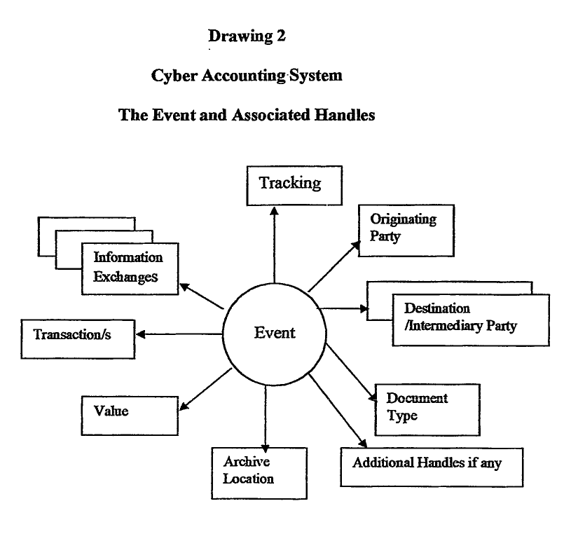

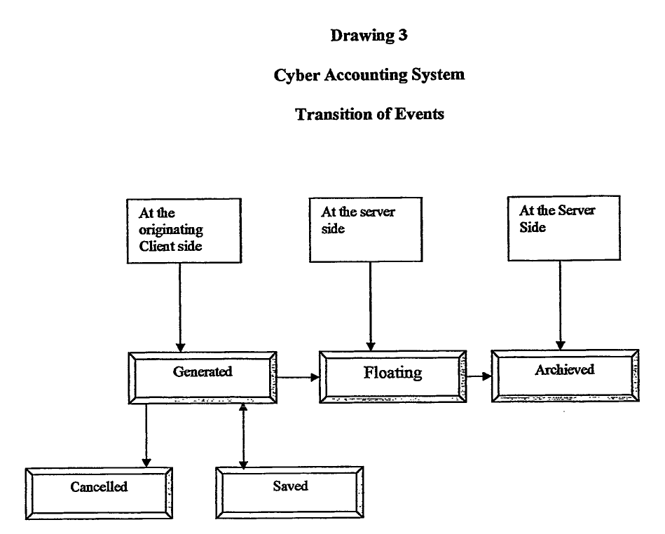

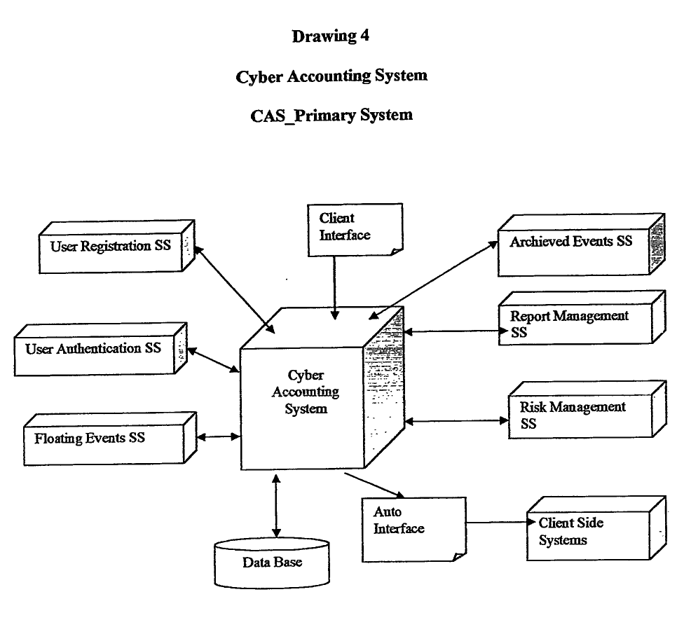

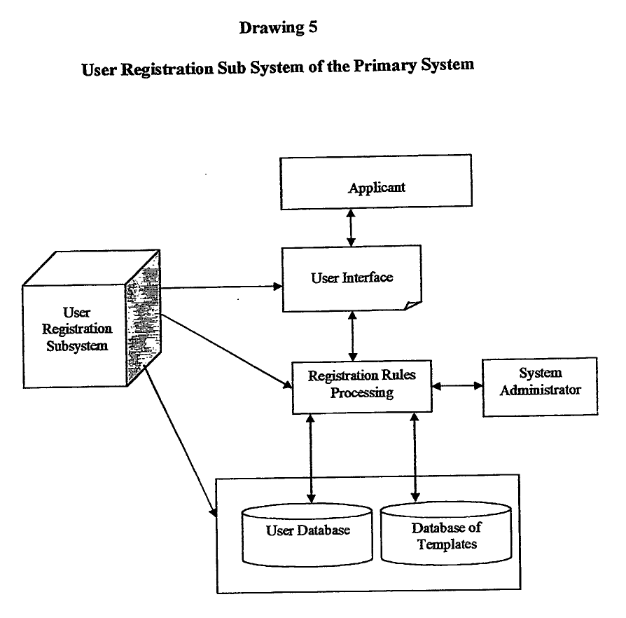

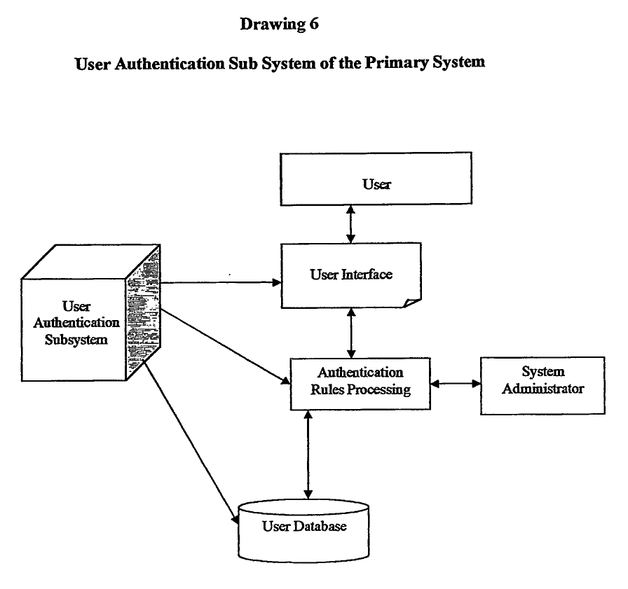

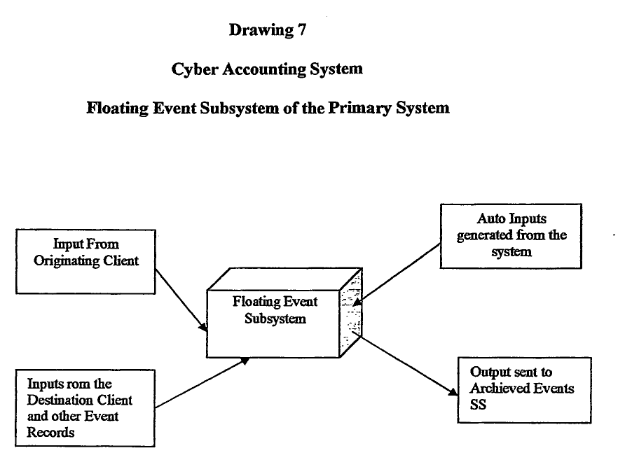

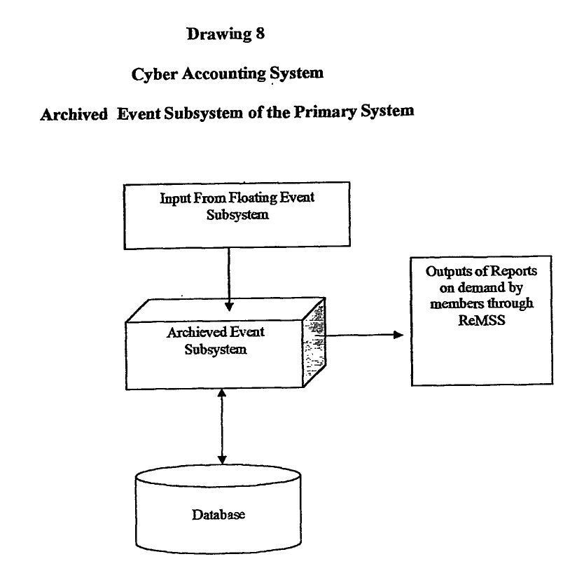

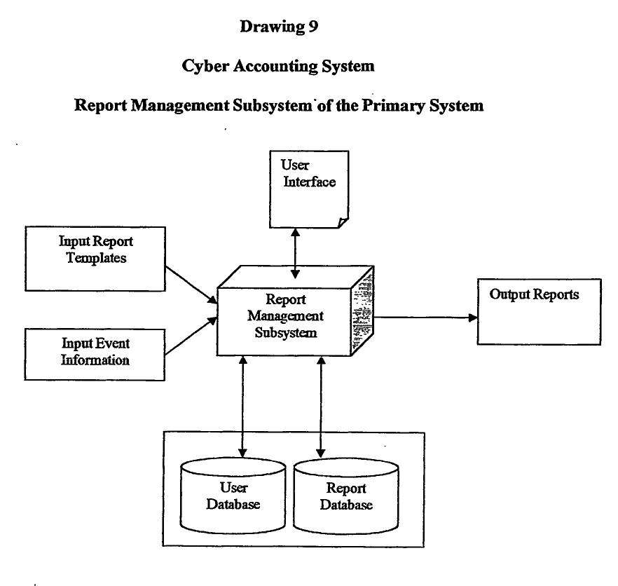

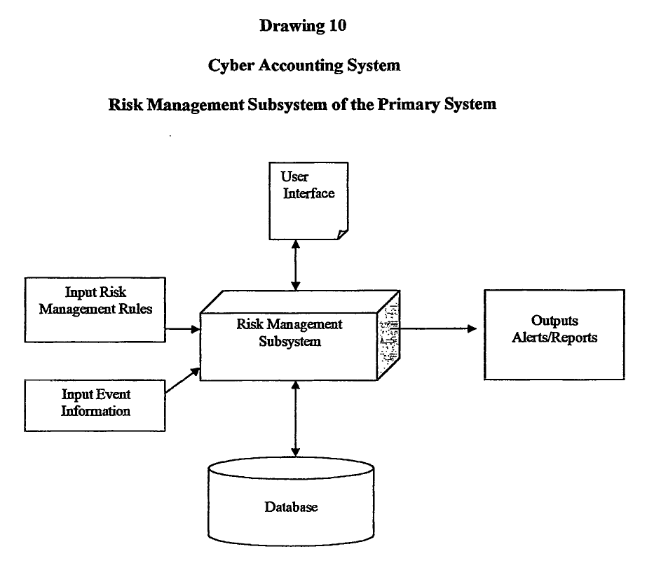

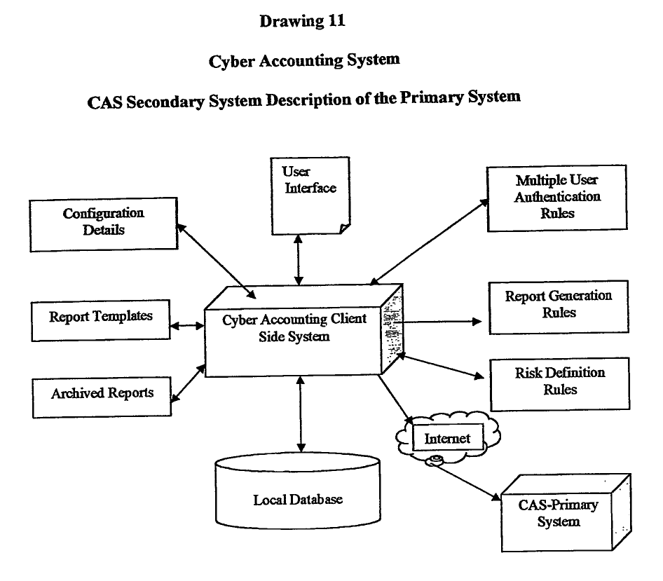

### FIELD OF THE INVENTION

The subject invention relates to methods and systems of accounting of transactions using Information Technology. It encompasses the traditional systems of financial accounting, inventory accounting, reconciliation of business transactions and Banking transactions.

### BACKGROUND OF THE INVENTION

Accounting Concept

Accounting is one of the oldest professions of business and consists of a systematic recording of business events. The purpose of accounting is to record events in such a manner that they can be collated or otherwise organized to draw meaningful information that would be helpful in conducting business.

Accounting can be for physical goods, an example being inventory accounting. Under this connotation accounting records the number of pieces of a given item in the possession of a business, number of such pieces manufactured or bought, number sold, number remaining etc.

Since the manager of a business would like to analyze different aspects and events on a common platform, the physical assets are reduced in the system of “Financial Accounting” to a common denominator of a currency. In financial accounting therefore all events are recorded in value terms with an accepted currency as a base. For example when 5 pieces of an equipment are sold, it would be recorded as “$ XYZ worth goods sold”. The reduction of every physical item into dollar value terms enables financial accounting to consolidate and arrange business transactions to reflect the totality in dollar terms.

While the primary information recorded in financial accounting is the event which originates an accounting record, the secondary information consists of reports generated out of such primary records. The examples of primary records are the “Vouchers” and examples of secondary records are “Journals”, “Ledgers” etc.

Financial accounting also generates many “Tertiary” records that are required for business analysis such as “Profit and Loss Accounts” and “Balance Sheets”.

There are various methods by which accounts of business transactions are kept. The most popular method of accounting is what is commonly referred to as “Double Entry Book Keeping” where every transaction is recorded in the books under two categories, the “Giver” and the “Receiver”. Under this system each business event is identified as affecting two “Heads of Account” one being the giver and the other being the receiver. The convention is to “Debit” the “Receiving Account” and “Credit” the “Giving Account”. Thus every business event gives raise to a set of debit and credit entries matching in value terms.

These records are then consolidated for a period and secondary statements and tertiary records/reports are generated.

Some accounting transactions may affect two accounting heads within the enterprise such as when salary account is debited and cash is paid out to an employee. Some accounting transactions however affect external parties such as when goods are sent to a customer or Cash is remitted to a Bank account

When a transaction takes place between two different business entities, the accounting records are generated at each of the entities. As a result, when goods are sold from one party A to another party B, the physical event of dispatch of goods gets recorded in a series of transaction sets each of which has the two elements of debit and credit.

For example when A sells goods to B worth $100, in the books of A, B's account is debited and Sales account is credited with an amount of $100. When this transaction comes to the knowledge of B, he records it as a debit of $100 to his Purchase account and credits to A's account in his books. Thus the one event of a dispatch of goods worth $100 is recorded at both ends of the transaction.

Subsequently when B makes a payment to A in the form of a cheque on Bank C, the originating party of this transaction namely B debits A's account in his books and credits his Bank account When the cheque comes to the hands of A, he will debit his Bank account and credit B's account in his book.

It may be observed that in such transactions the same event has to be recorded at two places with a lot of overlapping of information.

Again, the transaction continues with B handing over the cheque to his Banker say “D” who presents it to Banker “C” and gets the payment In this process both Bankers C and D have to pass their set of accounting records.

Additionally, both A and B also keep physical inventory records for managing the stores.

As a result of this system, one single business transaction of sending goods creates several sets of transactions to be accounted at different places.

During such multi party transactions, there will be a time lag for the information to reach from one end to the other. In such cases, one party would have taken into account the effect of the event while the other would not have. This results in an apparent discrepancy between the two parties which is explained through a record referred to popularly as the “Reconciliation Statement”.

In an actual business environment consisting of a multiplicity of parties and transactions, at any point of time, the account books between two entities always keep showing a discrepancy which needs to be reconciled. Hence “Reconciliation Statements” are important documents of the current accounting system along with documents such as “Profit and Loss” Accounts and Balance sheets.

Thus, duplicity of recording and need for continuous reconciliation are the two features of the accounting system that results in wastage of resources on a massive scale.

Changing Business Scenario

The developments in the business scenario in recent years all over the world indicate two distinct trends. First is the increasing use of Computers in record keeping as well as record generation and the second is the communication through networked computers.

Further, in the current scenario of Global business, Internet has been growing as a medium of choice for communication. The share of E-Commerce, where the business itself originates and is carried out on the Information network has also been growing day by day.

The power of the Information Technology makes it possible today to concurrently record a business event by different entities to a transaction situated at different parts of the globe and communicate it across the globe in fractions of seconds. Potential Accounting information is therefore shuttling across the global information highway in the form of information exchange about a business event.

Such transaction information presently passing through Cyber Space is not limited to virtual transactions where the goods exchanged are virtual goods and paid for with E-Money or online debits to the physical world money sources such as Bank accounts There is a significant level of physical world transaction information that is also being passed through Cyber Space either by use of the Electronic Data Exchange System or similar technological interfaces or a simple e-mail.

There are many virtual market places where customer acquisition, product selection and payment take place entirely on the Cyber Space, even though the back-end business is entirely physical world dependent.

As a result of this integration of physical world transactions with the Virtual mode of communication, transactions are getting completed across the Globe on a real-time basis. However the back-end system of “Accounting” of transactions which were developed initially for the physical world use have not undergone the required transformation for harnessing of the IT Power for efficient real time accounting systems.

Additionally, in the Banking system, there is an increased use of “Debit Card” and similar systems where an event such as “Swiping of a Debit Card” at a shopping mall immediately alters the Bank account of the card holder where as his account books remain unaltered until a voucher is passed and entered into the system.

It is as if the originating entry of such a transaction is initiated by the customer in the books of the Bank and only confirmation entries are entered in his books. This introduces the need for reconciliation even before the transaction is generated and becomes a possible source of accounting errors due to possibilities such as a wrongful entry or a missing of entry or incorrect allocation of transaction details such as tax component etc.

The Unfulfilled Need

In any business environment, it is not only the exchange of benefits that occur between two accounting entities within the enterprise that needs to be recorded, but also transactions that occur between one accounting enterprise and another accounting enterprise as well as one accounting enterprise with a set of external accounting enterprises concurrently affected by a business event.

When two different entities are involved in business, the accounting system as it exists today creates two different sets of accounts one in each enterprise. As a result when goods are sold by A to B, the sale is recorded in A's books and then the invoice is sent to B. Then the “Sale of A” gets recorded as “Purchase of B” in his books.

Since the current accounting systems of multiple enterprises are controlled independently, the single transaction of a sale from A to B gets recorded at both ends with similar details. Thus every transaction is duplicated at another end. In addition, at each of these places the records get backed up at least once and hence there are multiple copies of the same transaction in the total system.

If there was a system whereby the information of the event that generates the accounting entry could be shared by both enterprises, the data stored would be reduced by as much as 50% or more.

In the current IT scenario, it is possible for the systems to be built up with real time exchange of information without sacrifice of either privacy or security of data and the proposed system is set to achieve this integration of accounting across enterprises.

Additionally, in the existing system of accounting, every transaction generated at one enterprise will remain in float for a long time until it is suitably acknowledged at the destination enterprise. These records in float cause a need for “reconciliation” of account from time to time

If the accounting system could record transactions as and when they occur and match it with the destination response, the reconciliation would be achieved in real time. The subject invention is designed to achieve this objective.

When the same set of data is entered in two different entities for accounting purpose, there is also an enormous duplication of data input efforts accompanied by data verification and cost of managing data entry errors.

If the accounting systems are capable of sharing data then the need for data input at the second location which responds to the originating transaction is grossly reduced. The second enterprise can import the shared data already in the system and hence avoid the cost of reentry, verification and error management

These problems get multiplied when a transaction simultaneously affect multiple parties since the current accounting system duplicates entries in each of these entities rather than sharing a common data base of information.

In the current accounting systems, it often becomes necessary for the audit of one enterprise to depend on certain data from the other enterprise such as the “Confirmation of Balances”. Non receipt of such information or delay may cause hold up of finalization of accounting at the enterprise.

If therefore there was a means by which such confirmation data could be extracted from trusted third party data storage facilities, the need for one enterprise to depend on another for information before finalization of accounts would be eliminated.

The present process of accounting in Information Technology Environment has not harnessed the enormous potential of the Information Technology and the communication networks and the subject invention is designed for this purpose. The efforts are limited to either a server based processing of an accounting software on a shared application service or an electronic data interchange system between two business partners. There has been no change in the system of accounting which is still entity based and has to be duplicated at each entity. The prior art references goven below highlight these limitations.

An example of a reference Prior Art is represented by the Japanese Patent JP 2003099143 published on Apr. 4 2003, which attempts to provide an accounting system and method for allowing a software providing company to surely collect a fee, and to charge a customer to use application software by a method for easily budgeting fee payment This system environment is limited in its objective to provide for issuing tickets through client machines based on a pre-set fee structure stored in a control machine. The system accounts the tickets issued and is not meant as an accounting solution for the business transactions of an entity.

Another example of a reference prior art is a Canadian Patent CA2420033 published on 23^{rd} May 2002 which relates to an automated mobile method for remotely managing job-based resources through real time allocation of the resources among a set of user defined virtual spending accounts.

Additionally, reference can be made to U.S. Pat. No. 5,875,4311, dated May 18, 1998 which is an automated accounting system for an entity, such as an individual or business which can perform one or more activities related to the data inputs such as entering, deleting, reviewing, adjusting and processing.

Another reference can be made to U.S. Pat. No. 5,920,848 dated Jan. 22, 1998 which relates to the use of computerized intelligent agents to facilitate the integration of networked performance of financial transactions with computerized methods of financial accounting.

Yet another reference can be made to U.S. Pat. No. 6,609,0911 dated Jan. 21, 2000 which is an electronic financial accounting system for tracking financial transactions, applying electronic coupons, and facilitating updating of financial records.

All these current options are meant to integrate the physical accounting systems through electronic communication. They are either simple account processing software systems working on the user's end or systems which works as a “Shared Application” running on a server and accessible to many clients. The objective of all these inventions is to generate the legacy accounting records with the use of computerized means.

However, the novelty of the invention which is the subject matter of this application lies in its objective to provide a new system of “Concurrent Accounting of multiple entities” which substitutes the current methods of accounting.

The subject invention is also capable of producing accounting records of the legacy system as a transition requirement. This is essential for the community to change over from the current system to the new system and has to be part of any new invention.

The subject invention goes beyond the usual concept of sharing of an accounting application and redefines the concept of accounting itself as a process in the Cyber Space with concurrent Real time accounting entries of different entries getting created as soon as a “Transaction” is reported to the system.

It also approaches the traditional concept of “Reconciliation” of transactions as a wholly new concept of “Collation of Events in a specified Status” which enhances the utility of the business accounting process to a manager.

### DESRCRIPTION OF THE INVENTION

Brief Summary of the Invention

CAS is a novel method of Cyber Space based Accounting of intra-enterprise and inter-enterprise transactions on a real-time basis. It uses a unique system of recording of the transaction elements in Cyber Space in shared, transient and archived databanks securely accessible by multiple members of the system. It is designed to generate self configured information extracts on the fly, to meet the accounting needs of the members.

CAS is an accounting method that utilizes the power of Information Technology which was not available when the traditional accounting systems evolved in the commercial world and is an Information Technology solution to a real world accounting need.

CAS is not a system of accounting based on the principle of merely substituting Electronic documents in place of paper documents. It is a whole new method of real time accounting based on “Event” as a transaction trigger with appropriate handles created for electronic processing of the “Event”.

CAS is designed to generate concurrent accounting entries on a real time basis. However, in the best embodiment version, the system would be capable of both real time and non real time operation. In other words, if the accounting entities are online when a transaction event is reported to the system, the accounting happens in real time. If the users are not online when the event is first reported to the system, it will be temporarily stored in the user's computer where it is created and update the system at other computers whenever the user goes online and interacts with the application.

The system is capable of being developed on any standard software platform running on a standard computer device connected to a network and/or Internet

Detailed Description of the Invention

Cyber Accounting System (CAS) is an electronic information exchange and processing system that implements the new Concurrent accounting method described earlier.

It comprises of two parts namely the Primary System and the Secondary System. The primary system of the CAS system will reside and administered at a Server. The Secondary system is installed at the computers of each of the members who avail the service. The Primary and secondary systems of CAS interact with each other whenever the network connection is established.

The server based primary system along with several client based systems and the associated subsystems form the total CAS system which is the subject matter of this invention.

A graphic description of an overview of this system is given in Drawing 1.

Whenever the member user connects onto the network, the server interacts with the client side system to establish the identity and to authenticate of the member, establish an identity for the session, synchronize the event records in the two systems and to generate alerts on the basis of pre-programmed decision rules. Then the user invokes transaction reporting templates and exchanges the same with the server.

At the time of the first configuration of the system immediately after installation, the system will be configured to the requirement of the member. This will involve business rules as to the reporting of transactions, as well as configuration of different reports.

The Recording of an Event

One of the essential features of CAS is that any business transaction that needs to be converted into an accounting record will be captured at the originating point as an “Event”.

Every Event will be tagged with necessary handles to be available for the processing of the transactions triggered by the “Event”.

The essential Event handles are
1. Event Tracking Handle
2. The Originating Party Handle
3. The Destination Party Handle
4. Intermediary Parties Handle
11. Document Type Handle
6. Archive Location Handle
7. Value Handle
8. Transaction Handles Associated with the Event
9. Information Exchange Handles for Delivery and Acceptance between the event connected parties.
10. Additional Handles if any

The “Event” and the associated handles are visually depicted in Drawing 2.

The Event tracking handle is a system generated tracking number generated at the member/client side for further tracking of the event

The Originating Party handle is a signature imprint of the originating member. The destination and intermediary party handles are the imprints of the identity of other parties whose accounting is affected by the event.

The document type handle links the event to certain decision rules that may need to be invoked for the event.

Archive location handle refers to the location where the primary data of the event will be stored. By default this will be the server from which the service is controlled. Where necessary, the primary data of an event may be stored in a distributed network including the system of select clients themselves.

Value Handle refers to the “Value”.assigned to the event which may be a financial value in case of financial accounting or a physical value in the case of material accounting.

Each Event may trigger one or more “Transaction Records” which are records generated at the client side based on the decision rules set up by the member clients. These transaction records are generated on the fly and copies may or may not be held at the local data base of transactions at the client side.

Information Exchange handles refer to the tags assigned when an event is reported from the originating system to the server and from the server to the destination system as well as when the acknowledgement of the receipt of event report travels back from the destination system to the server and the server to the originating system. This system defines the status of the transaction from the point of view of the reconciliation requirements in the traditional system.

Depending on the requirements of a particular client or a transaction type, additional handles can be provided to any “Event”.

In certain cases an event can be considered complete when transactions between the participating members is completed though the Event has not completed its full life cycle as a business transaction.

A typical example would be when a sale takes place between A and B and both have accepted the transaction, the buyer has made the payment through a Bank instrument and the Bank has been requested to transfer the money by lodgment of cheque or otherwise.

Such a transaction is complete as between the two parties though not complete in the commercial sense until the paying Banker debits the money to the purchaser's account and he becomes aware of such debit and the collecting Bank transfers the money to the account of the seller and he becomes aware of the credit.

If however, the Banks are also members of the system, the lodging of cheque with the Bank, its presentation to the paying Bank, the debit to the drawee's account, inter bank transfer of the money and the final credit to the payees account, may all be defined as additional handles to the event.

Recording of an Event as required by the subject system can be integrated into the legacy transaction recording systems used by members through appropriate middleware so that the conversion/migration of legacy system based documents to input documents for the subject system can be automated.

Event Status

CAS recognizes three states of an Event as depicted in Drawing 3.

The first state is when the event is generated at the originating end and is not yet reported to the Server. This is a transient stage and is converted to the next state the moment the originating system interacts with the server. If the event is aborted without being reported to the server, the “Generated Event” may either be erased or be saved on specific request as “Draft” for being used later.

The second state is when the event is reported to the server but not all operations that are to be performed on the event are completed. At this stage, the event is recognized as being in a “Floating State”.

The third state is when the event has gone through all the operations that it is expected to go through. At this stage the event is recognized as being in an “Archived State”

Every event is assigned Event Definition once it is created by the originator. This definition is embedded in the event tracking number itself Subsequently the status recognition of such an event either as “Floating” or “Archived” depends on the handles prescribed in the originating definition. For example, events can be either Intra Enterprise or Inter Enterprise. Some events can be Multi Enterprise as well. The number and type of event handles that are assigned to each of these three different types of events would vary.

The “Floating Event” represents events or transactions which have not completed all operations. In such events some of the event handles would be empty. A report of such floating events arranged according to a specified originating and destination party handles automatically represents a list of “Unreconciled” Items in the normal accounting parlance.

An “Archived Event” is a completed transaction record where all the associated handles are “Full” Such event are kept in a data base and feed the generation of various reports that are called Journals, Ledgers etc in normal parlance.

Primary System Description

A detailed visual depiction of the Primary System is provided in Drawing 4.

The Primary system which is installed in the server consists of subsystems such as
1. User Registration Subsystem (URSS)
2. User Authentication Subsystem (UASS)
3. Floating Events Subsystem (FESS)
4. Archived Events Subsystem (AESS)
5. Report Management Subsystem (ReMSS)
6. Risk Management Subsystem (RiMSS)

The subsystems are detailed in drawings 5 to 10.

The system will also consist of a Client interface with which the members can interact with the system, a database to support the information management and an Auto interface with the subsystems on the client side through the Internet or other network connecting devices.

The Auto interface is invoked as soon as the authentication process is completed upon establishment of connectivity between the user's computer and the service providing server.

The user interface is the manually operated interface invoked simultaneously after authentication to enable the user interacts with the server side system.

The database contains all information necessary for the service including user configuration and event related information.

A brief description of the functionalities of the subsystems is as follows.

1. User Registration Subsystem (URSS)

The composition of URSS is depicted in Chart 5.

The CAS is a system of recording of business events of customers who subscribe to the system. If a business event has multiple party involvement and all the parties are members of CAS, the full advantage of the CAS concept can be reaped by all the parties in terms of saved database and real time reconciliation of transactions. However, if any party to an event is not a member, it does not affect the recording of events as for as the member is concerned.

The User registration system is the gateway to the members to the system. During this registration process, the members register the default configuration as well as the variable components of the system. For example the user needs to configure the Document Types Handle of an event which describes under which name of account the event is recognized in the system. Similarly, the Value Handle may be configured for Currency, the Information Exchange handle may be configured so as to define when an event is to be treated as complete for archival purpose, the Archival Location handle has to be configured to account for distributed processing etc. In the best use scenario, default configurations and pre-configured templates are provided for the members to complete the configuration during the registration system.

The registration system will also define the user's preferences regarding encryption of data and use of authentication technologies to secure the information flow.

2. User Authentication Subsystem (UASS)

The composition of UASS is depicted in Chart 6.

CAS system is a member oriented service and envisages real time or frequent interaction of the users with the system both at the secondary and primary layers.

The secondary system is installed in the user's own computer and standard system authentication procedures and application authentication procedures such as Passwords, Digital Signatures, Authentication Tokens, Biometric Authentications, will be used.

The server level authentication will also use standard system authentication procedures and application authentication procedures such as Passwords, Digital Signatures, Authentication Tokens, and Biometric Authentications. Appropriate security configurations to authenticate both the user and his system will be available for configuration at the time of user registration and the authentication system will be linked to such registration process and subsequent editing of the registration profile.

3. Floating Events Subsystem (FESS)

The composition of FESS is depicted in Chart 7.

Floating Events represent those Events which have been generated but have not completed their life cycle. The Life cycle of an Event is determined based on the handles allocated to it at the time of generation.

The Floating Event Subsystem captures the events reported by a member client and holds it in a temporary state until the Event completes its life cycle. It monitors the activities of the members and picks up actions that represent the handles allocated to an event Where necessary, it generates alerts to different parties prompting action required by them.

The FESS is invoked as soon as a member enters the system through the UASS. As soon as the member entry is reported, FESS will check for any Event already available with the system containing a handle indicating that the member is designated as a party to the Event.

If FESS does not identify any earlier Event with the member as one of the designated handles, it waits for any event to be reported by the member in the current session.

If FESS identifies a related event, (This would be the typical case where the member is a destination party of an event already registered by another member) the event would be reported to the member, the fact of report recorded.

Recording of the reporting of the event to the member is the completion of another handle of the event.

If the Event contains a handle requiring “Confirmation of Acceptance of Event” by the destination party the Event would continue “Floating” until such a confirmation is received either in the same session or in a subsequent session.

When all designated handles are completed, the Event would be treated as Complete and sent to Archived Events Database

One of the standard reports that the members can extract from the CAS is the list of Floating transactions under the handle of a designated originating member and a designated destination member. This will be a list of all business events between the two parties where action is pending from either of the parties. In the traditional accounting system, this is called a “Reconciliation Statement”.

Under CAS the traditional Reconciliation Statement can be generated dynamically. All the Events that move into “Archived Events” represent “Fully Reconciled” in the traditional concept.

The functioning of the “Floating Event Concept” is like an imaginary box to which a generated event is dropped and held until all transactions associated with it is completed. The content of such boxes represent “Unreconciled” transactions.

4. Archived Events Subsystem: (AESS)

The composition of AESS is depicted in Chart 8.

CAS records all business transactions that affect the accounting system as “Events” and assigns certain “Handles” that determine the designated flow of the “Event” in the system. As and when the transaction passes through a designated operation (e.g.: event being reported to the designated destination party or the designated party confirming acceptance of the event etc) the handle status changes from “Vacant” to “Full”.

When all the designated handles to an Event reach the “Full” status, the Event itself is treated complete. CAS then changes the status of the Event from “Floating” to “Archived” and hands it over to the AESS.

AESS moves the “Event” to a separate part of the database. Here the “Event” is available for interaction with the “Report Generation Subsystem” so that it can be used for creation of any report that the accounting system may require.

The information held by AESS represents the completed business transactions of a business entity and therefore contains confidential and critical information of an enterprise. Hence the access to this system is regulated by a secured authentication system and the data held securely. Standard encryption procedures including digital signatures may be used for securing this information.

In cases of highly sensitive information storage such as “Banking Information”, the AESS database may be located at a different location and only a pointer to the location is held by the AESS at the main server controlling the CAS.

Such distributed storage of database of archived transactions is accompanied by an embedded secure authentication mechanism so that access to the database by members is appropriately regulated.

For example, when a Bank is a participating member of CAS and two members A and B record their money settlement through cheque, the passing of the cheque by the Bank becomes a transaction affecting the Bank Account of the members in their books and the Archived Event of Depositing of a Bank Instrument to the Credit of a member's account results in updation of the customer's Bank Account.

At the same time in the member Bank's books, the Event updates the Customer's Bank Account Since the Bank may opt to hold the Customer's Bank Account details under its own control and linked to other applications that it operates, CAS provides for the information to be stored in the server under the full control of the Bank and holds only a reference number of the transaction as a pointer at the AESS of CAS at the main server.

Whenever a request is received for the information through the CAS, the special authentication mechanism is triggered at the distributed database location and the normal precautions that are taken by a Bank in providing access to the customer account are invoked.

5. Report Management Subsystem (ReMSS)

The composition of ReMSS is depicted in Chart 9.

The ReMSS enables members to define various statements that can be extracted out of CAS and satisfies all the needs of traditional accounting business.

The information required for various reports can be taken either from the main server where the Floating Events data and Archived Events data would be stored or from the local member side secondary system.

The typical report can be configured as Journals if it collates all events reported by a specified member for a given day. Another typical report can be configured as a ledger account of “Sundry Debtors-a/c XYZ” by collating all events reported within an accounting period, where the destination party handle is that of XYZ and the document type handle indicates that the event generates “Money Due from XYZ” type record.

Yet another report that can be configured is the Reconciliation Statement (Say of transactions with B in the books of A) which is extracted from the list of “Floating Events” with a given party handle of the member A as the originating party and B as the destination party.

ReMSS would contain default templates of basic accounting reports which can be chosen by the members through the URSS. Members may also be provided a facility to upload their own formats into the data base of Report Templates and configure them as required.

ReMSS with configurable reports enables the system to be used simultaneously by different users and in compliance of the report requirements relative to their accounting standards. For example the same event record can be used to generate the Balance sheet in India based on the Indian Accounting standards as well as a Balance sheet in USA based on the US accounting standards including different currency options.

The reports generated by the system showing different events and their current status are made visually communicative by assigning different colour codes to identify different states of a transaction when it is displayed on the screen.

6. Risk Management Sub System (RiMSS)

The composition of RiMSS is depicted in Chart 10.

RiMSS is a subsystem to identify any unusual patterns of usage of CAS which is indicative of a mistake, fraud or an attempted fraud. The decision rules of when an event is to be treated as “Suspected” and what actions are to be initiated may be configured by the members.

RiMSS will be activated by the URSS and monitor changes in the User information, authentication rules, and usage records and also provide for decision rules to be prescribed from time to time by an authorized administrator.

RiMSS will be embedded with a separate authentication rule which will be determined by the members themselves.

CAS-Secondary System (CAS-SS) at the Members Computer

A detailed visual depiction of the CAS-Secondary System is provided in Drawing 11.

CAS-SS is a client side system of the Total system. It interacts with the CAS-Primary System installed in the server and synchronizes itself from time to time. The synchronization would be in respect of event information to be exchanged and certain basic system parameters such as the System Clock.

CAS-SS will interact with a local data base where “Templates”, “Saved Reports”, “To be synchronized Event Information” etc. will be available.

CAS-SS will have several interfaces with which the member can interact with the system and use CAS. For example there will be an interface for User Registration, Modification of Registration Information etc. There, may be another interface for reporting of Events and yet another for Report generation etc.

The user will invoke the necessary interface; complete the particulars available with him. The system will attach certain particulars automatically as per previous configuration if any. The completed information will be kept ready to be synchronized with the Server as and when the member logs into the server at which point it will be assigned the necessary tracking identity. If the member creates the information to be sent to the server and does not log in immediately, the information will be stored in the local database for use at a later time.

Principle Benefits of the System

CAS defines a new system of accounting of business transactions. It is useful for accounting of both E-Commerce and Real world transactions using the benefits of instantaneous communication available to the community.

CAS segregates the transactions into internal and external and shares the information of external transactions with the corresponding external party.

CAS is capable of connecting multiple parties to a transaction to a common transaction information base and create a sharing environment on a secured access basis.

CAS database will contain records of Events from which the accounting records for each of the transacting parties can be drawn separately on the fly.

CAS saves data storage space substantially since the common data from the Events is used by 41 accounting members.

CAS saves substantially on processing time since common information of an event is captured at the originating stage and is automatically system generated in subsequent event processing. It has therefore an embedded Electronic Data Interchange capability.

CAS saves substantial time in preparing the traditional Reconciliation Statements which are available on the fly as a report of floating transactions.

CAS makes “Confirmation of Balances” redundant since every external transaction is registered with the system by the originator and is acknowledged by the system and subsequently by the responding party.

CAS develops complimentary accounting entries of the responding party to a transaction and in the case of financial intermediaries such as Banks, the complete accounting records of the intermediary is generated by the parties to the transaction and reducing the accounting requirements of the intermediary to only acknowledging the entries.

CAS provides a new dimension to the reconciliation statement in respect of multi party transactions. Unlike the traditional reconciliation system which is tracking the records between two parties from the known value to an unknown value through a recording of a series of transactions not accounted in the books, the reconciliation statement prepared by CAS provides an absolute value of pending transactions for all combinations of transaction parties.

CAS also provides a subject accounting entity better control over the accounting entries passed by external entities by providing immediate information and ability to acknowledge which is particularly useful in dealing with Banks which pass entries on a customer account without prior information.

CAS enables sharing of data without compromising on security since user authentication and distributed archived event database takes into account the different security needs of members.

CAS provides for use of digital signatures and biometric techniques of authentication and encryption to provide a legally compliant security standard for the accounting data

For Small Enterprises, CAS provides centralized accounting and account statement generation on real-time basis eliminating the need for complicated and expensive accounting software

In the best mode of use CAS can be served as an Application Service on the Internet to the global community and will be a highly cost efficient system of accounting for the community.

### BRIEF DESRCRIPTION OF THE DRAWINGS

Drawing 1: System description-1

Drawing 2: Event Associated Handles

Drawing 3: Transition of Events

Drawing 4: System Description-2 (CAS-Primary System)

Drawing 11: User Registration Subsystem

Drawing 6: User Authentication Subsystem

Drawing 7: Floating Events Subsystem

Drawing 8: Archived Events Subsystem

Drawing 9: Report Management Subsystem

Drawing 10: Risk Management Subsystem

Drawing 11: CAS-Secondary System

1. The subject invention is a method of recording business events in a shared virtual space and processing them on a concurrent basis to generate business accounting records of multiple entities, said method comprising the steps of
A. Capturing the business event details with a predefined set of handles
B. Monitoring the Event continuously as a floating event and updating the status of the handles until the predefined life cycle of the event is completed
C. Holding the Completed event details in the archived event data base
D. Making the data available on a shared basis for generating accounting records by members

2. The subject invention is a method as claimed in claim 1 where an entity administering the system registers multiple users who can concurrently operate on an event that affects any one or more of them.

3. The subject invention is a method as claimed in claim 1 where an event is designated with a pre-configured set of associated handles

4. The subject invention is a method as claimed in claim 1 where the handles of an event originated by one of the members are filled up by subsequent actions of the other members associated with the transaction.

5. The subject invention is a method as claimed in 1 where the accounting records of each of the members is generated as per pre-configured reports.

6. The subject invention is a System to implement the method as claimed in claim 1 where a primary system working on a server interacts with a plurality of secondary systems working on client computers for the recording and processing of business events.

7. The subject invention is a System to implement the method as claimed in claim 1, where in business transactions are recorded as “Events” and the defined transaction flow is recorded as different “Event Handles”.

8. The subject invention is a System to implement the method as claimed in claim 1, where in the reconciliation statement of business transactions with different entities is embedded in the system of recording of the business transaction itself so as to enable the reconciliation statement to be generated on the fly as a type of status of the event object.

9. The subject invention is a System to implement the method as claimed in claim 1, where multi party transactions are accounted concurrently in Cyber Space.

10. The subject invention is a System to implement the method as claimed in claim 1, where accounting records at the responding enterprise get automatically updated partially from the sharable data from the originating entry so that complimentary data entry requirement is eliminated.

11. The subject invention is a System to implement the method as claimed in claim I where the transactions are held in a “Floating Container” whose “Full” or “Empty” status indicates the status of reconciliation of the transaction.

12. The subject invention is a System to implement the method as claimed in claim 1, where the users can visually track the status of a transaction with an appropriate color code.

13. The subject invention is a System to implement the method as claimed in claim 1, where the reconciliation of a multi party transaction is captured as a multi dimensional reconciliation statement reflecting both the financial and non financial parameters of the transaction.

14. The subject invention is a System to implement the method as claimed in claim 1, where records at one of the entities modified before an originating entry is passed at another entity in the conventional accounting process are accounted simultaneously at both ends.

15. The subject invention is a System to implement the method as claimed in claim 1, where a secured common database of transactions serves the accounting requirements of multiple members.

16. The subject invention is a System to implement the method as claimed in claim 1, where the data base can be distributed and partly held as a common sharable database and partly as a member controlled database to which pointers can be provided in the shared database along with secured access control.

17. The subject invention is a System to implement the method as claimed in claim 1, where the members can use both real time as well as non real-time data synchronization for creation of accounting records.

18. The subject invention is a System to implement the method as claimed in claim 1, where in the input templates can be integrated with legacy accounting systems for automatic migration from existing systems.

19. The subject invention is a System to implement the method as claimed in claim 1, where an inherent risk management system tracks the transactions and develops alerts.

20. The subject invention is a System to implement the method as claimed in claim 1, where transaction reports from one member of the system can be dropped in an electronic drop box in the form of transaction handles which can be picked up by another designated member of the system.

21. The subject invention is a Method as claimed in claim 1 and a System as Claimed in claim 6 where data is collaboratively built by multiple parties to a transaction by adding inputs to different handles associated with the transaction.
